(19) United States
(12) Patent Application Publication
(10) Pub. No.: US 2017/0004527 A1
(43) Pub. Date: Jan. 5, 2017

(54) SYSTEMS, METHODS, AND DEVICES FOR SCALABLE DATA PROCESSING

(71) Applicant: Turn Inc., Redwood City, CA (US)

(72) Inventors: Mingxi Wu, Redwood City, CA (US); Alvin Chyan, Redwood City, CA (US); Lawrence Lo, Redwood City, CA (US)

(73) Assignee: Turn Inc., Redwood City, CA (US)

(21) Appl. No.: 14/789,954

(22) Filed: Jul. 1, 2015

(51) Int. Cl. G06Q 30/02

(52) U.S. Cl. CPC G06Q 30/0255; G06Q 30/0277

(57) ABSTRACT

Systems, methods, and devices are disclosed for scalable integration of data events received from data providers. Systems include data aggregators configured to receive data records generated by data providers and user profile data generated by an online advertisement service provider. The data records and the user profile data each identify data events and users. Systems include data provider record generators configured to generate first data provider records and second data provider records based on identifiers included in the data records and user profile data. Systems include partition record generators configured to generate provider partition records based on the first data provider records, and mapping partition records based on the second data provider records. The mapping partition records may include a second user identifier mapping. Systems include partition record analyzers configured to generate new data events based on the second user identifier mapping and contents of the provider partition records.

### TECHNICAL FIELD

This disclosure generally relates to online advertising, and more specifically to scalable data processing associated with online advertising.

### BACKGROUND

In online advertising, internet users are presented with advertisements as they browse the internet using a web browser or mobile application. Online advertising is an efficient way for advertisers to convey advertising information to potential purchasers of goods and services. It is also an efficient tool for non-profit/political organizations to increase the awareness in a target group of people. The presentation of an advertisement to a single internet user is referred to as an ad impression.

Billions of display ad impressions are purchased on a daily basis through public auctions hosted by real time bidding (RTB) exchanges. In many instances, a decision by an advertiser regarding whether to submit a bid for a selected RTB ad request is made in milliseconds. Advertisers often try to buy a set of ad impressions to reach as many targeted users as possible. Advertisers may seek an advertiser-specific action from advertisement viewers. For instance, an advertiser may seek to have an advertisement viewer purchase a product, fill out a form, sign up for e-mails, and/or perform some other type of action. An action desired by the advertiser may also be referred to as a conversion.

### SUMMARY

Disclosed herein are systems, methods, and devices for scalable integration of data events received from data providers. In various embodiments, systems may include a data aggregator configured to receive a plurality of data records generated by at least one data provider. The data aggregator may be further configured to receive user profile data generated by an online advertisement service provider, the plurality of data records and the user profile data each identifying at least one data event and at least one user, and the user profile data including a first user identifier mapping. The systems may also include a data provider record generator configured to generate a first plurality of data provider records based on a first plurality of identifiers included in the plurality of data records. In some embodiments, the data provider record generator may be further configured to generate a second plurality of data provider records based on a second plurality of identifiers included in the user profile data. The systems may also include a partition record generator configured to generate a plurality of provider partition records based on the first plurality of data provider records. In various embodiments, the partition record generator may be further configured to generate a plurality of mapping partition records based on the second plurality of data provider records, the plurality of mapping partition records including a second user identifier mapping. The systems may also include a partition record analyzer configured to generate a plurality of new data events based on the second user identifier mapping represented in the plurality of mapping partition records and at least some of the plurality of provider partition records. In various embodiments, the partition record analyzer may be further configured to update the user profile data based on a combination of at least some of the plurality of new data events and at least some of the user profile data.

In various embodiments, the plurality of data records includes a first plurality of data values characterizing a first plurality of provider user identifiers associated with a first plurality of users, a first plurality of data events associated with the first plurality of users, and a first plurality of data provider identifiers associated with a first plurality of data providers. Moreover, the user profile data may include a second plurality of data values characterizing a second plurality of provider user identifiers associated with a second plurality of users, a second plurality of data events associated with the second plurality of users, and a second plurality of data provider identifiers associated with a second plurality of data providers. In various embodiments, each data provider record of the first plurality of data provider records is generated based on a data provider identifier of the first plurality of data provider identifiers, and each data provider record of the second plurality of data provider records is generated based on a data provider identifier of the second plurality of data provider identifiers.

According to some embodiments, each provider partition record of the plurality of provider partition records is generated based on at least one provider user identifier of the first plurality of provider user identifiers, and each mapping partition record of the plurality of mapping partition records is generated based on at least one provider user identifier of the second plurality of provider user identifiers. In some embodiments, each provider partition record of the plurality of provider partition records represents a portion of the first plurality of provider user identifiers, and each mapping partition record of the plurality of mapping partition records represents a portion of the second plurality of provider user identifiers. In various embodiments, the partition record generator is further configured to generate the plurality of provider partition records by applying a mapping function to the first plurality of provider user identifiers included in the first plurality of data provider records. Moreover, the partition record generator may be further configured to generate the plurality of mapping partition records by applying the mapping function to the second plurality of provider user identifiers included in the second plurality of data provider records.

In some embodiments, the partition record analyzer is further configured to identify corresponding partition records of the plurality of provider partition records and the plurality of mapping partition records. Moreover, the partition record analyzer may be further configured to compare provider user identifiers included in the corresponding partition records. Furthermore, the partition record analyzer may be further configured to generate the plurality of new data events based on the comparison. In some embodiments, the partition record analyzer may be further configured to store the updated user profile data in a data storage system associated with an online advertisement service provider. In various embodiments, the partition record analyzer is further configured to replace previously stored user profile data with the updated user profile data to generate updated user profiles and performance data associated with online advertisement campaigns. In various embodiments, the user profile data includes a plurality of performance data objects characterizing performance data capable of being used by an online advertisement campaign.

Also disclosed herein are devices that may include a first processing node configured to receive a plurality of data records generated by at least one data provider. The first processing node may be further configured to receive user profile data generated by an online advertisement service provider, the plurality of data records and the user profile data each identifying at least one data event and at least one user, and the user profile data including a first user identifier mapping. In some embodiments, the devices may also include a second processing node configured to generate a first plurality of data provider records based on a first plurality of identifiers included in the plurality of data records. The second processing node may be further configured to generate a second plurality of data provider records based on a second plurality of identifiers included in the user profile data. The devices may further include a third processing node configured to generate a plurality of provider partition records based on the first plurality of data provider records. The third processing node may be further configured to generate a plurality of mapping partition records based on the second plurality of data provider records, the plurality of mapping partition records including a second user identifier mapping. The devices may also include a fourth processing node configured to generate a plurality of new data events based on the second user identifier mapping represented in the plurality of mapping partition records and at least some of the plurality of provider partition records. The fourth processing node may be further configured to update the user profile data based on a combination of at least some of the plurality of new data events and at least some of the user profile data.

In various embodiments, the plurality of data records includes a first plurality of data values characterizing a first plurality of provider user identifiers associated with a first plurality of users, a first plurality of data events associated with the first plurality of users, and a first plurality of data provider identifiers associated with a first plurality of data providers. Moreover, the user profile data may include a second plurality of data values characterizing a second plurality of provider user identifiers associated with a second plurality of users, a second plurality of data events associated with the second plurality of users, and a second plurality of data provider identifiers associated with a second plurality of data providers. In various embodiments, each data provider record of the first plurality of data provider records is generated based on a data provider identifier of the first plurality of data provider identifiers. Moreover, each data provider record of the second plurality of data provider records is generated based on a data provider identifier of the second plurality of data provider identifiers. In some embodiments, each provider partition record of the plurality of provider partition records is generated based on at least one provider user identifier of the first plurality of provider user identifiers. Moreover, each mapping partition record of the plurality of mapping partition records may be generated based on at least one provider user identifier of the second plurality of provider user identifiers.

In various embodiments, the third processing node is further configured to generate the plurality of provider partition records by applying a mapping function to the first plurality of provider user identifiers included in the first plurality of data provider records. Moreover, the third processing node may be further configured to generate the plurality of mapping partition records by applying the mapping function to the second plurality of provider user identifiers included in the second plurality of data provider records. In some embodiments, the fourth processing node is further configured to identify corresponding partition records of the plurality of provider partition records and the plurality of mapping partition records. Moreover, the fourth processing node may be further configured to compare provider user identifiers included in the corresponding partition records. Furthermore, the fourth processing node may be further configured to generate the plurality of new data events based on the comparison.

Also disclosed herein are one or more non-transitory computer readable media having instructions stored thereon for performing a method, where the method includes receiving a plurality of data records generated by at least one data provider and user profile data generated by an online advertisement service provider, the plurality of data records and the user profile data each identifying at least one data event and at least one user, and the user profile data including a first user identifier mapping. The methods may also include generating a first plurality of data provider records based on a first plurality of identifiers included in the plurality of data records. The methods may further include generating a second plurality of data provider records based on a second plurality of identifiers included in the user profile data. The methods may also include generating a plurality of provider partition records based on the first plurality of data provider records. The methods may additionally include generating a plurality of mapping partition records based on the second plurality of data provider records, the plurality of mapping partition records including a second user identifier mapping. The methods may further include generating a plurality of new data events based on the second user identifier mapping represented in the plurality of mapping partition records and at least some of the plurality of provider partition records. The methods may also include updating the user profile data based on a combination of at least some of the plurality of new data events and at least some of the user profile data.

In various embodiments, the plurality of data records includes a first plurality of data values characterizing a first plurality of provider user identifiers associated with a first plurality of users, a first plurality of data events associated with the first plurality of users, and a first plurality of data provider identifiers associated with a first plurality of data providers. Moreover, the user profile data may include a second plurality of data values characterizing a second plurality of provider user identifiers associated with a second plurality of users, a second plurality of data events associated with the second plurality of users, and a second plurality of data provider identifiers associated with a second plurality of data providers. Furthermore, each data provider record of the first plurality of data provider records may be generated based on a data provider identifier of the first plurality of data provider identifiers. Further still, each data provider record of the second plurality of data provider records may be generated based on a data provider identifier of the second plurality of data provider identifiers.

In some embodiments, the generating of the plurality of provider partition records and the generating of the plurality of mapping partition records further include applying a mapping function to the first plurality of provider user identifiers included in the first plurality of data provider records, and applying the mapping function to the second plurality of provider user identifiers included in the second plurality of data provider records. In various embodiments, the method further includes identifying corresponding partition records of the plurality of provider partition records and the plurality of mapping partition records, comparing provider user identifiers included in the corresponding partition records, and generating the plurality of new data events based on the comparing.

### BRIEF DESCRIPTION OF THE DRAWINGS

FIG. 1 illustrates an example of an advertiser hierarchy, implemented in accordance with some embodiments.

FIG. 2 illustrates a diagram of an example of a system for importing and processing data associated with an advertisement campaign, implemented in accordance with some embodiments.

FIG. 3 illustrates a flow chart of an example of a scalable data processing method, implemented in accordance with some embodiments.

FIG. 4 illustrates a flow chart of an example of another scalable data processing method, implemented in accordance with some embodiments.

FIG. 5 illustrates a flow chart of an example of yet another scalable data processing method, implemented in accordance with some embodiments.

FIG. 6 illustrates a flow chart of an example of another scalable data processing method, implemented in accordance with some embodiments.

FIG. 7 illustrates a data processing system configured in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting.

In online advertising, advertisers often try to provide the best ad for a given user in an online context. Advertisers often set constraints which affect the applicability of the advertisements. For example, an advertiser might try to target only users in a particular geographical area or region who may be visiting web pages of particular types for a specific campaign. Thus, an advertiser may try to configure a campaign to target a particular group of end users, which may be referred to herein as an audience. As used herein, a campaign may be an advertisement strategy which may be implemented across one or more channels of communication. Furthermore, the objective of advertisers may be to receive as many user actions as possible by utilizing different campaigns in parallel. As previously discussed, an action may be the purchase of a product, filling out of a form, signing up for e-mails, and/or some other type of action. In some embodiments, actions or user actions may be advertiser-defined and may include an affirmative act performed by a user, such as inquiring about or purchasing a product and/or visiting a certain page.

In various embodiments, an ad from an advertiser may be shown to a user with respect to publisher content, which may be a website or mobile application if the value for the ad impression opportunity is high enough to win in a real-time auction. Advertisers may determine a value associated with an ad impression opportunity by determining a bid. In some embodiments, such a value or bid may be determined based on the probability of receiving an action from a user in a certain online context multiplied by the cost-per-action goal an advertiser wants to achieve. Once an advertiser, or one or more demand-side platforms that act on their behalf, wins the auction, it is responsible to pay the amount that is the winning bid.

Data objects and data events associated with advertisement campaign activity may be generated by various entities, such as servers and browsers, during the implementation of an advertisement campaign. Accordingly, such data may be performance data that may be indicative of a performance of one or more advertisement campaigns. For example, such data may be analyzed to determine various performance metrics, such as a return-on-investment, which may characterize or describe a return-on-investment provided by an advertisement campaign during a particular period of time. Performance data as well as other data about users that may be included in an audience associated with the performance data may be collected by various entities, such as third party data providers. As discussed herein, a third party data provider may be a data provider that has collected data that may characterize or describe interactions between at least one user and at least one advertisement campaign of a separate entity, which may be an online advertiser. Moreover, data collected by third party data providers may include offline data that characterizes or describes a user's offline activities. Accordingly, such third party data providers may collect data, such as online and offline performance data, and may send such data to a different entity, such as an online advertisement service provider, for subsequent analysis and use by the advertisers that subscribe to services provided by the online advertisement service provider.

Thus, data providers may aggregate and send large amounts of offline and/or online data to an online advertisement service provider over the course of a period of time, such as a business day. For example, in a single day more than 3 terabytes of data provider data may be received. Such data may include over 8 billion data records. As used herein, a data record may refer to a data structure or data entity received from a data provider. Conventional techniques for processing and incorporating data received from data providers are not able to process and incorporate all of this data within a relatively small time window, which may be a business day or a portion of a business day. As discussed above, the amount of data may be very large and conventional techniques are often not able to incorporate such a large amount of data fast enough to enable online advertisers to use the received data effectively because such conventional techniques may add files incrementally and such a process may take upwards of several hours for each new file or record. Furthermore, conventional techniques are not scalable and require large amounts of processing overhead which are often not practical.

Various methods, systems, and devices are disclosed herein that provide scalable data processing for online advertising. In various embodiments, data records may be received from data providers. As discussed above, the data providers may be third party data providers that provide such data records to an online advertisement service provider. In various embodiments, a system component, such as a data analyzer, may generate data provider records based on the received records. As will be discussed in greater detail below, the data provider records may be data structures including received or retrieved data organized or arranged such that each data provider record is specific to a particular data provider. The data provider records may be partitioned into smaller data records, which may be referred to herein as provider partition records. The data analyzer may similarly generate data provider records and mapping partition records based on audience and performance data, such as audience profile data, already stored in a data storage system. As disclosed herein and discussed in greater detail below, mapping partition records may be partitions generated based on the audience profile data or other data stored in a data storage system. In various embodiments, the audience profile data may also be analyzed to generate a user identifier mapping. The data analyzer may subsequently analyze and compare data values included in the different partitions to modify the data records received from the data providers based on the user identifier mapping, and to combine the received data records with the data stored in the data storage system, thus updating the data storage system to include the most recent performance data associated with its audience of users. In various embodiments, the analysis of the partition may be implemented in parallel. Accordingly, the combining may be implemented as part of a single join operation performed on the partition records, thus, reducing processing overhead and integrating the new data in a scalable manner.

Accordingly, various embodiments disclosed herein provide novel techniques for receiving and combining large amounts of performance data and user profile data to increase the quality and accuracy of data underlying the implementation and analysis of online advertisement campaigns. As discussed above, in a period of time, such as a business day, more than 3 terabytes of data may be received that includes more than 8 billion data records. Various embodiments disclosed herein may join such a large amount of data with more than 31 terabytes of existing data to generate billions of new data events that may be stored for subsequent analysis. Various embodiments disclosed herein enable such joining or ingestion of data to within a designated time period or operational window, which may be a day or a portion of a day. For example, the joining of data and generation of new data events may occur within 3 to 4 hours. Thus, received data may be used to generate various data structures characterizing data events, as well as user identifier mappings associated with such data events, and such data structures may be configured to enable the efficient, scalable, and high-throughput integration of such data events with various other data previously stored in a data storage system. In this way, processing systems used to implement such analyses and operations may be improved to implement online advertisement campaigns more effectively because the underlying data includes more recent data. As will be discussed in greater detail below, the partitioning of data provider records as well as a user identifier mapping enables processing systems to analyze and combine data in ways not previously possible. Accordingly, embodiments disclosed herein enable processing systems to analyze and integrate data faster such that greater amounts of data received from data providers may be analyzed and used within a particular operational window.

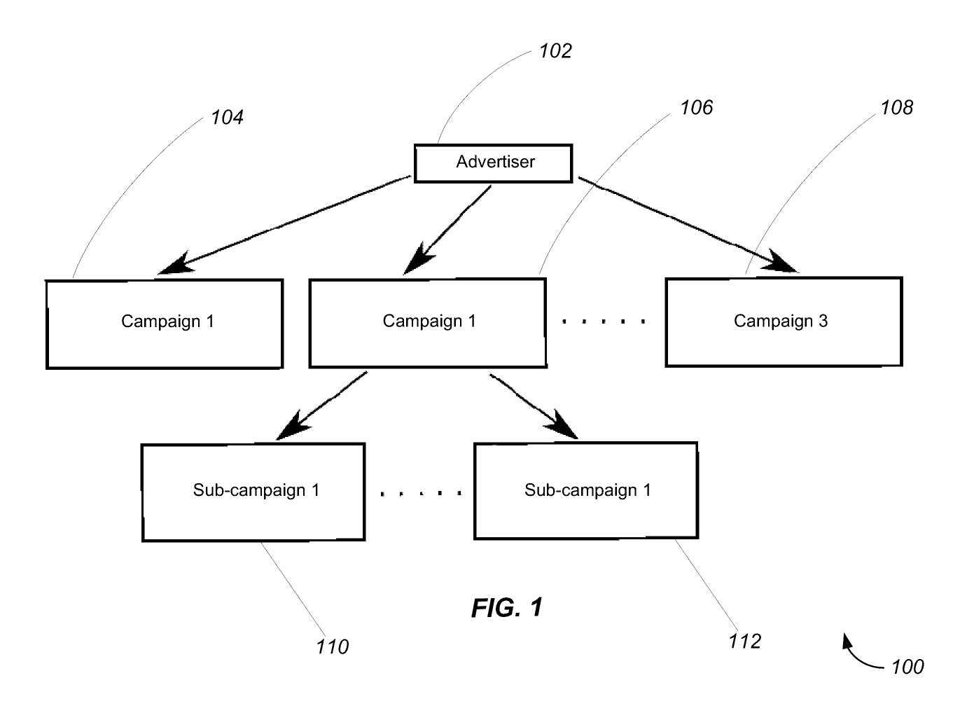

FIG. 1 illustrates an example of an advertiser hierarchy, implemented in accordance with some embodiments. As previously discussed, advertisement servers may be used to implement various advertisement campaigns to target various users or an audience. In the context of online advertising, an advertiser, such as the advertiser 102, may display or provide an advertisement to a user via a publisher, which may be a web site, a mobile application, or other browser or application capable of displaying online advertisements. The advertiser 102 may attempt to achieve the highest number of user actions for a particular amount of money spent, thus, maximizing the return on the amount of money spent. Accordingly, the advertiser 102 may create various different tactics or strategies to target different users. Such different tactics and/or strategies may be implemented as different advertisement campaigns, such as campaign 104, campaign 106, and campaign 108, and/or may be implemented within the same campaign. Each of the campaigns and their associated sub-campaigns may have different targeting rules which may be referred to herein as an audience segment. For example, a sports goods company may decide to set up a campaign, such as campaign 104, to show golf equipment advertisements to users above a certain age or income, while the advertiser may establish another campaign, such as campaign 106, to provide sneaker advertisements towards a wider audience having no age or income restrictions. Thus, advertisers may have different campaigns for different types of products. The campaigns may also be referred to herein as insertion orders.

Each campaign may include multiple different sub-campaigns to implement different targeting strategies within a single advertisement campaign. In some embodiments, the use of different targeting strategies within a campaign may establish a hierarchy within an advertisement campaign. Thus, each campaign may include sub-campaigns which may be for the same product, but may include different targeting criteria and/or may use different communications or media channels. Some examples of channels may be different social networks, streaming video providers, mobile applications, and web sites. For example, the sub-campaign 110 may include one or more targeting rules that configure or direct the sub-campaign 110 towards an age group of 18-34 year old males that use a particular social media network, while the sub-campaign 112 may include one or more targeting rules that configure or direct the sub-campaign 112 towards female users of a particular mobile application. As similarly stated above, the sub-campaigns may also be referred to herein as line items.

Accordingly, an advertiser 102 may have multiple different advertisement campaigns associated with different products. Each of the campaigns may include multiple sub-campaigns or line items that may each have different targeting criteria. Moreover, each campaign may have an associated budget which is distributed amongst the sub-campaigns included within the campaign to provide users or targets with the advertising content.

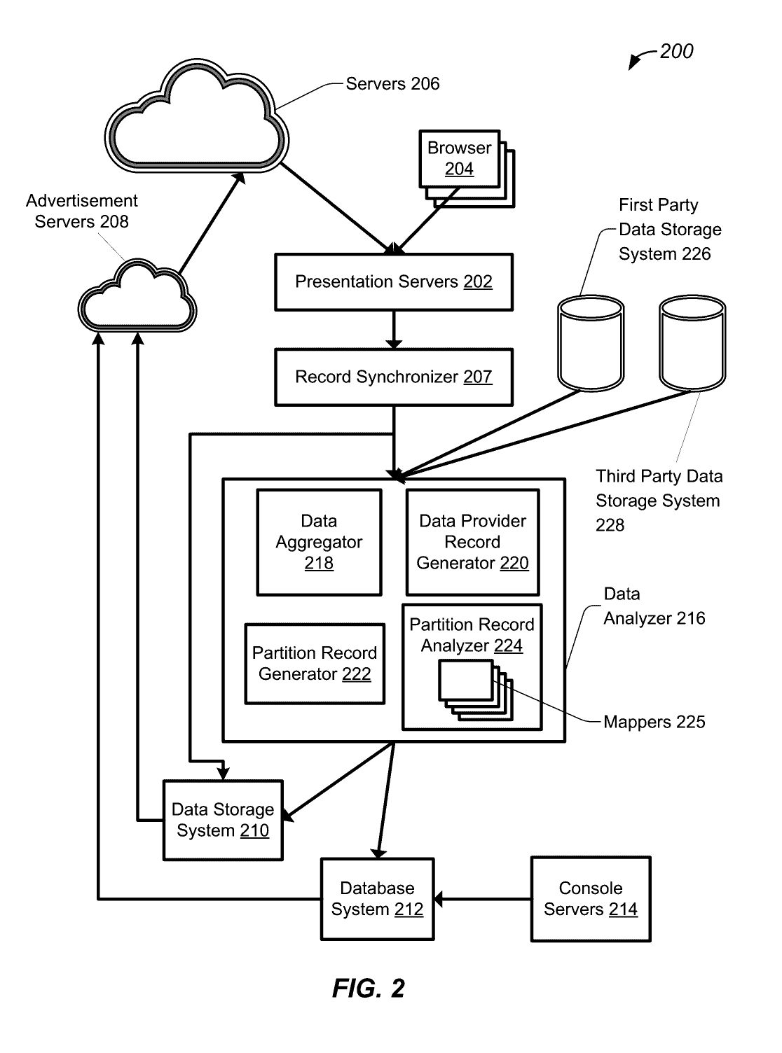

FIG. 2 illustrates a diagram of an example of a system for importing and processing data associated with an advertisement campaign, implemented in accordance with some embodiments. As similarly discussed above, in the context of online advertising, various data events characterizing interactions between users and online advertisement campaigns may be recorded and stored by various data sources. In some embodiments, such data may be recorded and stored by third party data providers. Accordingly, one or more components of system 200 may be implemented to receive and partition data such that large amounts of data may be processed in parallel to incorporate such data with audience data stored in a data storage system in an effective and scalable manner.

In various embodiments, system 200 may include one or more presentation servers, such as presentation servers 202. According to some embodiments, presentation servers 202 may be configured to aggregate various online advertising data from several data sources. The online advertising data may include live internet data traffic that may be associated with users, as well as variety of supporting tasks. For example, the online advertising data may include one or more data values identifying various impressions, clicks, data collection events, and/or beacon fires that may characterize interactions between users and one or more advertisement campaigns. As discussed herein, such data may also be described as performance data that may form the underlying basis of analyzing a performance of one or more advertisement campaigns. In some embodiments, presentation servers 202 may be front-end servers that may be configured to process a large number of real-Internet users, and associated SSL (Secure Socket Layer) handling. The front-end servers may be configured to generate and receive messages to communicate with other servers in system 200. In some embodiments, the front-end servers may be configure to perform logging of events that are periodically collected and sent to additional components of system 200 for further processing.

As similarly discussed above, presentation servers 202 may be communicatively coupled to one or more data sources such as browser 204 and servers 206. In some embodiments, browser 204 may be an Internet browser that may be running on a client machine associated with a user. Thus, a user may use browser 204 to access the Internet and receive advertisement content via browser 204. Accordingly, various clicks and other actions may be performed by the user via browser 204. Moreover, browser 204 may be configured to generate various online advertising data described above. For example, various cookies, advertisement identifiers, beacon fires, and user identifiers may be identified by browser 204 based on one or more user actions, and may be transmitted to presentation servers 202 for further processing. As discussed above, various additional data sources may also be communicatively coupled with presentation servers 202 and may also be configured to transmit similar identifiers and online advertising data based on the implementation of one or more advertisement campaigns by various advertisement servers, such as advertisement servers 208 discussed in greater detail below. For example, the additional data servers may include servers 206, which may process bid requests and generate one or more data events associated with providing online advertisement content based on the bid requests. Thus, servers 206 may be configured to generate data events characterizing the processing of bid requests and implementation of an advertisement campaign. Such bid requests may be transmitted to presentation servers 202.

In various embodiments, system 200 may further include record synchronizer 207 which may be configured to receive one or more records from various data sources that characterize the user actions and data events described above. In some embodiments, the records may be log files that include one or more data values characterizing the substance of the user action or data event, such as a click or conversion. The data values may also characterize metadata associated with the user action or data event, such as a timestamp identifying when the user action or data event took place. According to various embodiments, record synchronizer 207 may be further configured to transfer the received records, which may be log files, from various end points, such as presentation servers 202, browser 204, and servers 206 described above, to a data storage system, such as data storage system 210 or database system 212 described in greater detail below. Accordingly, record synchronizer 207 may be configured to handle the transfer of log files from various end points located at different locations throughout the world to data storage system 210 as well as other components of system 200, such as data analyzer 216 discussed in greater detail below. In some embodiments, record synchronizer 207 may be configured and implemented as a MapReduce system that is configured to implement a MapReduce job to directly communicate with a communications port of each respective endpoint and periodically download new log files.

As discussed above, system 200 may further include advertisement servers 208 which may be configured to implement one or more advertisement operations. For example, advertisement servers 208 may be configured to store budget data associated with one or more advertisement campaigns, and may be further configured to implement the one or more advertisement campaigns over a designated period of time. In some embodiments, the implementation of the advertisement campaign may include identifying actions or communications channels associated with users targeted by advertisement campaigns, placing bids for impression opportunities, and serving content upon winning a bid. In some embodiments, the content may be advertisement content, such as an Internet advertisement banner, which may be associated with a particular advertisement campaign. The terms “advertisement server” and “advertiser” are used herein generally to describe systems that may include a diverse and complex arrangement of systems and servers that work together to display an advertisement to a user's device. For instance, this system will generally include a plurality of servers and processing nodes for performing different tasks, such as bid management, bid exchange, advertisement and campaign creation, content publication, etc. Accordingly, advertisement servers 208 may be configured to generate one or more bid requests based on various advertisement campaign criteria. As discussed above, such bid requests may be transmitted to servers 206.

In various embodiments, system 200 may include data analyzer 216 which may be configured to receive and process data from various data sources to enable the scalable incorporation of large amounts of data, which may be first or third party data, into a data storage system, such as data storage system 210 described in greater detail below. As discussed herein, such receiving and processing of data, also described herein as data ingestion, may be implemented to incorporate large amounts of first and/or third party data with data stored and maintained by an online service provider, such as Turn® Inc. of Redwood City, Calif. As will be discussed in greater detail below, data analyzer 216 may be configured to process the data such that the subsequent joining of the data may be performed in a scalable fashion capable of handling the large amount of first and/or third party data that has been received.

Accordingly, data analyzer 216 may include data aggregator 218 which may be configured to identify, receive, and/or retrieve data from various different data sources. In various embodiments, the data received by data aggregator 218 may include various data records describing or characterizing data events associated with various online entities. For example, a data record may include a series of data events characterizing interactions between a user and advertisements and impressions of an online advertisement campaign. Data aggregator 218 may be configured to receive the data records from first party data sources or third party data sources. In some embodiments, the first party data sources may be entities, such as advertisers, which may have recorded and generated a data event based on an interaction with a user. Accordingly, data aggregator 218 may be configured to receive data records from first party data storage system 226 which may be a local data store associated with the entity. Data aggregator 218 may be further configured to receive the data records from third party data sources which may be third party data providers. In various embodiments, such third party data providers may periodically collect and store event data associated with online entities, such as users. Such data collected by the third party data providers may be stored in records in third party data storage system 228, and may be transmitted to data analyzer 216. In various embodiments, the records may include data values that characterize a particular data event, a unique user identifier that identifies a user associated with the event, and a data source identifier which identifies a data source from which the data event was received or detected. In some embodiments, the unique identifier associated with the user may be a provider user identifier which may be a unique identifier generated by the third party data provider to identify a particular user.

While a single first party data storage system and a single third party data storage system are shown, multiple first party and third party data storage systems may be coupled to data analyzer 216 and data aggregator 218. As discussed above and in greater detail below, data aggregator 218 may be further configured to retrieve data stored in data storage system 210, such as user profile data, for subsequent data processing and data ingestion.

Data analyzer may further include data provider record generator 220 which may be configured to process data received by data aggregator 218 to generate data records or files based on the received data. In various embodiments, the received data may have been received from a third party data provider, and may have been included in one or more data records received from the third party data provider. In some embodiments, a received data record may include an identifier, such as a data provider identifier, which may be a unique identifier associated with a particular third party data provider. The received data record may further include a several data events and provider user identifiers associated with the data events which, as discussed above, may be provider-generated identifiers that identify users associated with the data events. In various embodiments, system 200 may receive such data records from numerous different third party data providers and at many different times during a period of time, such as a business day.

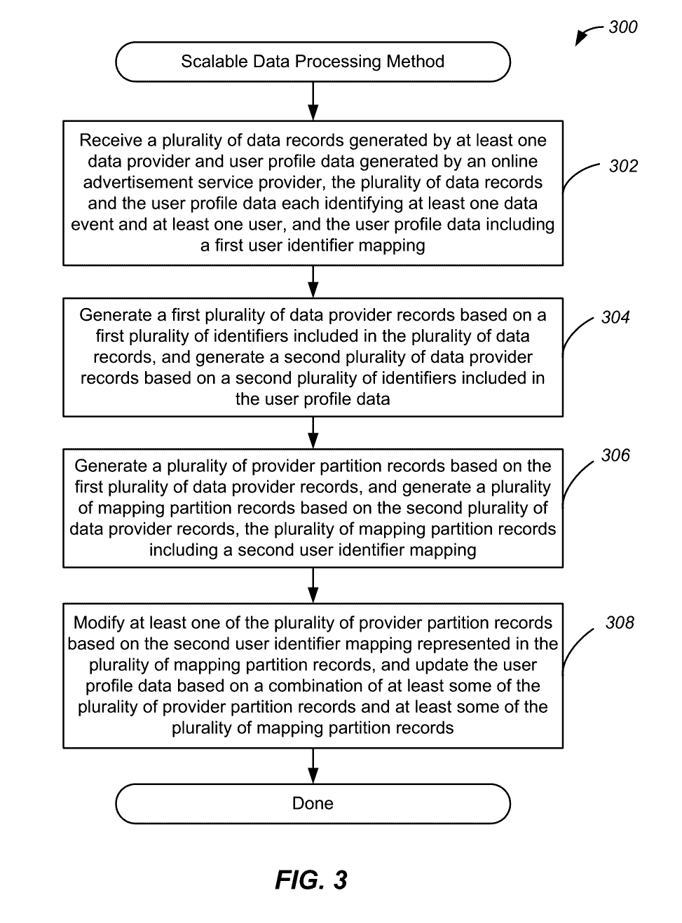

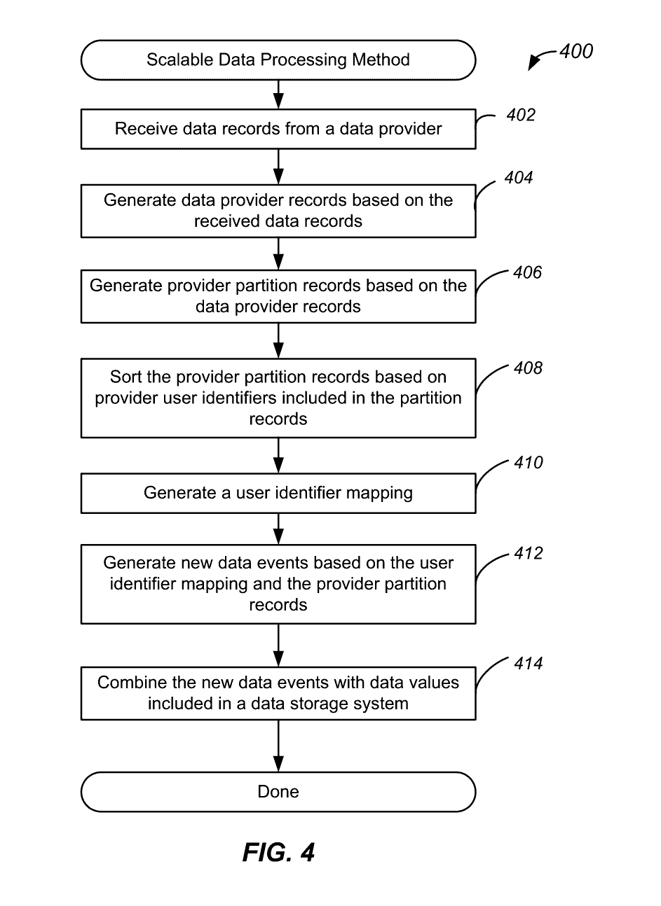

In various embodiments, data provider record generator 220 may be configured to analyze the received data records, and generate data records, files, or folders, such as data provider records, based on the received data. For example, data provider record generator 220 may be configured to query the received data and identify all received data records that were received from a particular third party data provider, as may be identified based on a data provider identifier included in each received data records. Data provider record generator 220 may be further configured to merge any identified data records into a single file, folder, or record which may be stored as a data provider record. Accordingly, each data provider record may include data values characterizing an aggregation of all data events and associated provider user identifiers provided by a third party data provider over a designated period of time. In this way, data provider record generator 220 may be configured to organize data including various different received data records into one or more data structures, where each data structure is associated with a single data provider. As will be discussed in greater detail below with reference to FIG. 3 and FIG. 4, data provider record generator 220 may be further configured to similarly generate data provider records based on user profile data maintained by an online service provider which may be retrieved from a data storage system, such as data storage system 210.

Data analyzer 216 may also include partition record generator 222 which may be configured to generate partition records based on the data provider records that were generated by data provider record generator 220. Accordingly, partition record generator 222 may be configured to receive data provider records from data provider record generator 220, and may be further configured to partition each of the data provider records into multiple provider partition records. In various embodiments, the data may be partitioned based on the provider user identifiers included in each data provider record. As will be discussed in greater detail below with reference to FIG. 4, data values characterizing data events may be mapped to different partition records based on designated ranges of provider user identifier numbers. For example, data events associated with users having provider user identifiers of “001” through “400” may be mapped to a first partition record, while data events associated with users having provider user identifiers of “401” through “800” may be mapped to a second partition record. As will be discussed in greater detail below, the provider user identifiers assigned to partitions may be determined based on one or more mapping functions. In this way, each data provider record may be partitioned into several different partition records based on provider user identifiers included in the data provider records. As will be discussed in greater detail below, partition record generator 222 may be further configured to implement similar partition operations on data provider records generated from user profile data stored in data storage system 210 to generate mapping partition records.

In various embodiments, data analyzer 216 may further include partition record analyzer 224 which may be configured to analyze partition records and modify the provider partition records based on a user identifier mapping represented in the mapping partition records. Moreover, partition record analyzer 224 may be further configured to update user profile data stored in a data storage system, such as data storage system 210. Accordingly, partition record analyzer 224 may be configured to identify provider partition records and corresponding mapping partition records that were generated based on the user profile data retrieved from data storage system 210. Partition record analyzer 224 may also be configured to merge data included in the provider partition records with user profile data stored in data storage system 210, where the merging is based, at least in part, on the user identifier mapping represented in the mapping partition records. As discussed in greater detail below, partition record analyzer 224 may be configured to instantiate or generate a designated number of mappers, such as mappers 225, to implement such an analysis of partition records. In this way, newly received event data included in the data received from data sources, such as the third party data providers, may be merged with data stored in a data storage system operated and maintained by an online advertisement service provider. Furthermore, because the data has been partitioned into numerous different partition records, large amounts of data may be processed in parallel by different instances of processing units, such as mappers 225, included in a data processing system, thus enabling the scalable ingestion of data associated with users and online advertisement campaigns.

In various embodiments, data analyzer 216 or any of its respective components may include one or more processing devices configured to process data records received from various data sources. In some embodiments, data analyzer 216 may include one or more communications interfaces configured to communicatively couple data analyzer 216 to other components and entities, such as a data storage system and a record synchronizer.

Furthermore, as similarly stated above, data analyzer 216 may include one or more processing devices specifically configured to process performance data associated with data events and online users. In one example, data analyzer 216 may include several processing nodes, specifically configured to handle processing operations on large data sets. For example, data analyzer 216 may include a first processing node configured as data aggregator 218, a second processing node configured as data provider record generator 220, a third processing node configured as partition record generator 222, and a fourth processing node configured as partition record analyzer 224. In another example, data aggregator 218 may include big data processing nodes for processing large amounts of performance data in a distributed manner. In one specific embodiment, data analyzer 216 may include one or more application specific processors implemented in application specific integrated circuits (ASICs) that may be specifically configured to process large amounts of data in complex data sets, as may be found in the context referred to as “big data.”

In some embodiments, the one or more processors may be implemented in one or more reprogrammable logic devices, such as a field-programmable gate array (FPGAs), which may also be similarly configured. According to various embodiments, data analyzer 216 may include one or more dedicated processing units that include one or more hardware accelerators configured to perform pipelined data processing operations. For example, as discussed in greater detail below, operations associated with the generation of data provider records and partition records may be processed, at least in part, by one or more hardware accelerators included in data provider record generator 220 and partition record generator 222.

In various embodiments, such large data processing contexts may involve performance data stored across multiple servers implementing one or more redundancy mechanisms configured to provide fault tolerance for the performance data. In some embodiments, a MapReduce-based framework or model may be implemented to analyze and process the large data sets disclosed herein. Furthermore, various embodiments disclosed herein may also utilize other frameworks, such as .NET or grid computing.

In various embodiments, system 200 may include data storage system 210. In some embodiments, data storage system 210 may be implemented as a distributed file system. As similarly discussed above, in the context of processing online advertising data from the above described data sources, there may be many terabytes of log files generated every day. Accordingly, data storage system 210 may be implemented as a distributed file system configured to process such large amounts of data. In one example, data storage system 210 may be implemented as a Hadoop® Distributed File System (HDFS) that includes several Hadoop® clusters specifically configured for processing and computation of the received log files. For example, data storage system 210 may include two Hadoop® clusters where a first cluster is a primary cluster including one primary namenode, one standby namenode, one secondary namenode, one Jobtracker, and one standby Jobtracker. The second node may be utilized for recovery, backup, and time-costing query. Furthermore, data storage system 210 may be implemented in one or more data centers utilizing any suitable multiple redundancy and failover techniques.

In various embodiments, system 200 may also include database system 212 which may be configured to store data generated by data analyzer 216, discussed in greater detail below. In some embodiments, database system 212 may be implemented as one or more clusters having one or more nodes. For example, database system 212 may be implemented as a four-node RAC (Real Application Cluster). Two nodes may be configured to process system metadata, and two nodes may be configured to process various online advertisement data, which may be performance data, that may be utilized by data analyzer 216. In various embodiments, database system 212 may be implemented as a scalable database system which may be scaled up to accommodate the large quantities of online advertising data handled by system 200. Additional instances may be generated and added to database system 212 by making configuration changes, but no additional code changes.

In various embodiments, database system 212 may be communicatively coupled to console servers 214 which may be configured to execute one or more front-end applications. For example, console servers 214 may be configured to provide application program interface (API) based configuration of advertisements and various other advertisement campaign data objects. Accordingly, an advertiser may interact with and modify one or more advertisement campaign data objects via the console servers. In this way, specific configurations of advertisement campaigns may be received via console servers 214, stored in database system 212, and accessed by advertisement servers 216 which may also be communicatively coupled to database system 212. Moreover, console servers 214 may be configured to receive requests for analyses of performance data, and may be further configured to generate one or more messages that transmit such requests to other components of system 200.

FIG. 3 illustrates a flow chart of an example of a scalable data processing method, implemented in accordance with some embodiments. In various embodiments, a scalable data processing method, such as method 300, may be implemented to process and ingest large amounts of data that may be received from various different data sources, such as data providers. As will be discussed in greater detail below, method 300 may be implemented to process and ingest such large amounts of data to enable the accurate operation and implementation of online advertisement campaigns based on recently available performance data which would not otherwise be available in conventional systems.

Accordingly, method 300 may commence with operation 302 during which a plurality of data records may be received. The plurality of data records may have been generated by at least one data provider. Furthermore, user profile data generated by an online advertisement service provider may also be received. In some embodiments, the plurality of data records and the user profile data each identify at least one data event and at least one entity associated with the at least one data event. Moreover, the user profile data may also include a first user identifier mapping. As discussed above, the plurality of data records may be data files or records received over a period of time from various different third party data providers. Moreover, the user profile data may be data records corresponding to those third party data providers that have been previously stored in a data storage system operated and maintained by an online advertisement service provider. In various embodiments, the plurality of data records may include one or more data values that may be used to identify the data records for subsequent analysis, as will be discussed in greater detail below. For example, the data records may be identified based on metadata, such as timestamp metadata, identifying a creation date or a date received, which may or may not be within a designated time period set by an online advertisement service provider. In some embodiments, the plurality of data records may be identified based on one or more features or characteristics of a filename associated with each data record, which may also identify a creation date or a date at which the data record was received.

Method 300 may proceed to operation 304, during which a first plurality of data provider records may be generated based on a first plurality of identifiers included in the plurality of data records, and a second plurality of data provider records may be generated based on a second plurality of identifiers included in the user profile data. Accordingly, as similarly discussed above with reference to FIG. 2 and discussed in greater detail below, the received and retrieved data may be processed and filtered based on third party data provider identifiers that identify which data was received from which third party data provider. In this way, the received and retrieved data may be arranged or organized into different data provider records specific to each third party data provider. Moreover, as discussed above, a first set of data provider records may be generated based on the data records that were received from the third party data providers and a second set of data provider records may be generated based on data stored in a data storage system operated and maintained by an online advertisement service provider, such as Turn Inc. of Redwood City, Calif.

Method 300 may proceed to operation 306, during which a plurality of provider partition records may be generated based on the first plurality of data provider records, and a plurality of mapping partition records may be generated based on the second plurality of data provider records. In some embodiments, the plurality of mapping partition records includes a second user identifier mapping. Accordingly, a system component, such as a partition record generator, may partition the first plurality of data provider records and the second plurality of data provider records based on one or more features or characteristics, such as provider user identifiers, included in the first plurality of data provider records and the second plurality of data provider records. Moreover, the second user identifier mapping may be partitioned into portions and may be collectively represented by the plurality of mapping partition records.

Method 300 may proceed to operation 308, during which at least one of the plurality of provider partition records may be modified based on the second user identifier mapping represented in the plurality of mapping partition records. Moreover, the user profile data may be updated based on a combination of at least some of the plurality of provider partition records and at least some of the plurality of mapping partition records. Accordingly, as will be discussed in greater detail below, the first plurality of provider partition records may be modified to convert its included user identifier mapping from a first user domain to a second user domain, thus enabling the integration of data included in the provider partition data records with a storage system that uses the second user domain. Furthermore, during operation 308, at least some of the data included in the first plurality of partition records may be joined or merged with user profile data stored in a data storage system. In this way, new data events included in the data received from the third party data providers may be joined or merged with data stored in the data storage system maintained by an online advertisement service provider. Moreover, according to some embodiments, many different partitions may be processed concurrently to provide a large throughput and scalability that enables large numbers of new data events to be integrated with the data storage system such that online advertisement campaigns are provided with the most recent performance data when implementing online advertisement campaigns.

FIG. 4 illustrates a flow chart of an example of another scalable data processing method, implemented in accordance with some embodiments. As similarly discussed above with reference to FIG. 3, a scalable data processing method may be implemented to process and ingest large amounts of data that may be received from various different data sources, such as third party data providers. As will be discussed in greater detail below, method 400 may be implemented to process large amounts of data received from data providers as well as large amounts of data stored in a data storage system to combine and update the data stored in the data storage system, thus, enabling the accurate operation and implementation of online advertisement campaigns that may utilize performance data stored in the data storage system.

Method 400 may commence with operation 402 during which data records may be received from a data provider. In some embodiments, the data records may be received at a system component, such as a data aggregator. As similarly discussed above, the data records may be received from a third party data provider or a first party data provider. The data records may include data values that identify data events and users associated with those data events. Accordingly, each data record may include a collection of data events aggregated by a third party data provider. Moreover, the third party data provider may aggregate such data events or generate a report of such data events for a particular feature, characteristic, or data category associated with users such as gender, type of shopper, and browsing behavior.

In some embodiments, the users may be identified by unique identifiers determined or generated by an entity, such as the third party data provider. Thus, identifiers included in the data records may be provider user identifiers that are determined based on a provider user domain. As disclosed herein, a user domain may be a mapping scheme implemented to map users to unique identifiers. In various embodiments, the use of such user domains enables efficient identification of users via a set of data values, and may anonymize the identity of the users. The data records received during operation 402 may be provided to the data aggregator periodically at designated times during a designated time period. For example, the records may be provided to the data aggregator at designated times during a business day. In some embodiments, the data records may be provided to the data aggregator dynamically and/or responsive to one or more conditions being satisfied. For example, a data record may be sent from a data provider to the data aggregator every time one thousand data events have been recorded by the data provider.

Method 400 may proceed to operation 404 during which data provider records may be generated based on the received data records. Accordingly, a first set or group of provider records may be generated by a system component, such as a data provider record generator. As similarly discussed above, the records may be grouped or arranged based on one or more identifiers included in the records. In some embodiments, the identifiers may be provider identifiers that identify the data provider from which the record was received. Accordingly, a system component, such as a data provider record generator, may query the received data records, identify one or more data records received from a particular data provider, and merge or combine the identified data records into a single data structure which may be a data provider record. In various embodiments, the data provider record generator may generate such a data provider record for every data provider from which a data record has been received. In this way, all data records received from a single data provider during a particular period of time may be merged or combined into a single data provider record, and multiple data provider records may be generated that each include an aggregation of data events received from a particular data provider over a period of time. In various embodiments, the data provider records may be data structures such as data folders each configured to store provider partition records discussed in greater detail below. Accordingly, during operation 404, multiple data structures, such as folders may be generated, where each folder may be generated for each data provider, and each folder may be configured to store a data provider's corresponding and subsequently generated provider partition records.

Method 400 may proceed to operation 406 during which provider partition records may be generated based on the data provider records. In various embodiments, the partition record generator may be configured to apply one or more deterministic algorithms to the data provider records to partition the data provider records into smaller data records. In some embodiments, the partitioning may be performed based on a user domain associated with a data provider. For example, a particular data provider record received from a data provider may include provider user identifiers generated by the data provider according to a provider user domain, and used by the data provider to associate users with data events and user profile data characterized by the data provider record. The partition record generator may identify the provider user identifiers included in the data provider record, and may assign data events associated with the provider user identifiers to different partition records based on the provider user identifiers. For example, data events associated with provider user identifiers included in a first numerical range may be assigned to a first partition, while data events associated with provider user identifiers included in a second numerical range may be assigned to a second partition, and data events associated with provider user identifiers included in a third numerical range may be assigned to a third partition. As similarly discussed above, the provider partition records may be stored in data structures, such as folders, that may have been generated for each data provider during operation 404 discussed above.

More specifically, a partitioning function may be applied to the provider user identifiers. In some embodiments, the partitioning function is a modulus function that divides each provider user identifier by a designated number to obtain a remainder. As similarly discussed above, provider user identifiers may be represented as numerical strings. Accordingly, provider user identifiers may be associated with different provider partition records based on the remainders determined by the application of the modulus function to the provider user identifiers. In some embodiments, several provider user identifiers may be associated with each provider partition record. Accordingly, a first provider partition record may include data events associated with provider user identifiers having a value of 0, 400, and 800. Moreover, a second provider partition record may include data events associated with provider user identifiers having a value of 055, 455, and 855. Furthermore, a third provider partition record may include data events associated with provider user identifiers having a value of 099, 399, and 799. In this way numerous provider partition records may be generated for each data provider, and each provider partition record may include data events and/or user data for a set of users assigned to that partition record based on the partitioning function. As similarly discussed above, each provider partition record may be stored in a data structure, such as a folder, that is the data provider record.

Method 400 may proceed to operation 408 during which the provider partition records may be sorted based on provider user identifiers included in the provider partition records. Accordingly, a system component, such as a partition record generator, may be configured to apply one or more sorting operations to the provider partition records generated during operation 406. In some embodiments, the sorting operations may sort data included in the partitions based on a characteristic or feature of the data, such the provider user identifiers. For example, the data values characterizing data events may be sorted in ascending or descending order based on a numeric value of the provider user identifier that is associated with each data event. In this way, data events included in the partitioned data may be sorted and ordered based on features of the data, such as provider user identifiers determined based on a data provider user domain.

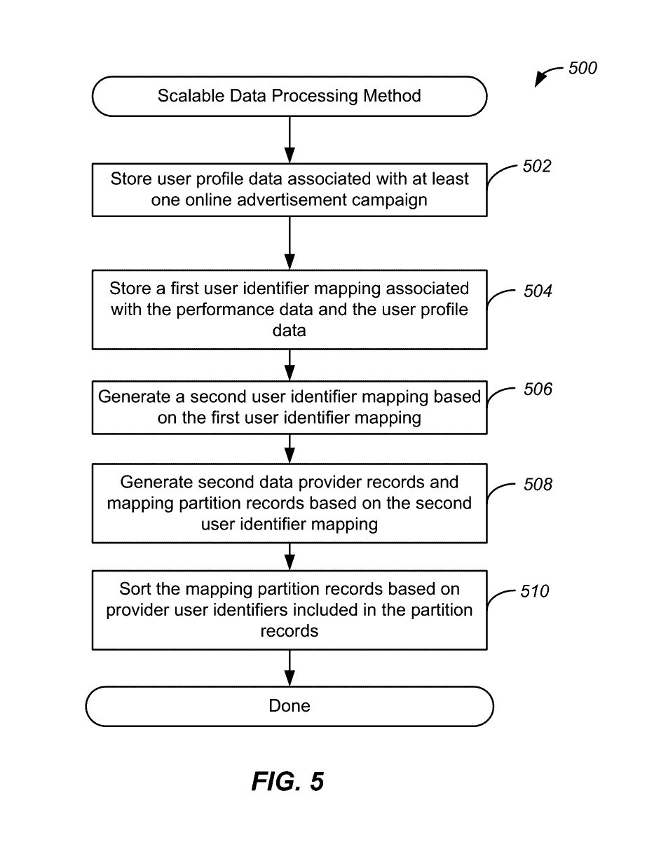

Method 400 may proceed to operation 410 during which a user identifier mapping may be generated. As will be discussed in greater detail below with reference to FIG. 5, the user identifier mapping may be capable of mapping provider user identifiers to local user identifiers. As disclosed herein, local user identifiers may be user identifiers generated based on a user domain configured by an online advertisement service provider. In some embodiments, the user identifier mapping generated during operation 410 may be a reverse mapping of a previously generated user identifier mapping. Thus, according to some embodiments, a previously generated user identifier mapping may have been generated during previous implementations of online advertisement campaigns and previous retrieval of data from data providers. Accordingly, as will be discussed in greater detail below, the previously generated user identifier mapping may be retrieved, and modified to generate a new user identifier mapping that is capable of mapping provider user identifiers to local user identifiers. As discussed in greater detail below, the user identifier mapping may be further processed to generate mapping partition records that correspond to the provider partition records. Processing the user identifier mapping in this way enables the parallel processing of the partitions and large amounts of data included therein, thus enabling efficient scanning of received data as well as integration of the received data with user profile data stored in a data storage system operated and maintained by an online advertisement service provider.

Accordingly, the user identifier mapping may be divided into different data structures based on provider identifiers. As discussed above and in greater detail below, the user identifier mapping may be stored in provider-specific data structures such as data folders. The user identifier mapping may be partitioned based on provider user identifiers included in the user identifier mapping. Accordingly, each provider data structure may include partitions that each include a portion of provider user identifier to local user identifier mappings. As similarly discussed above, each partition may be sorted based on provider user identifiers included in each partition such that mappings of identifiers within each partition are sorted and ordered based on provider user identifiers included in the mappings. Accordingly, as will be discussed in greater detail below with reference to FIG. 5, a user identifier mapping may be generated that includes mapping partition records that correspond with the provider partition records.

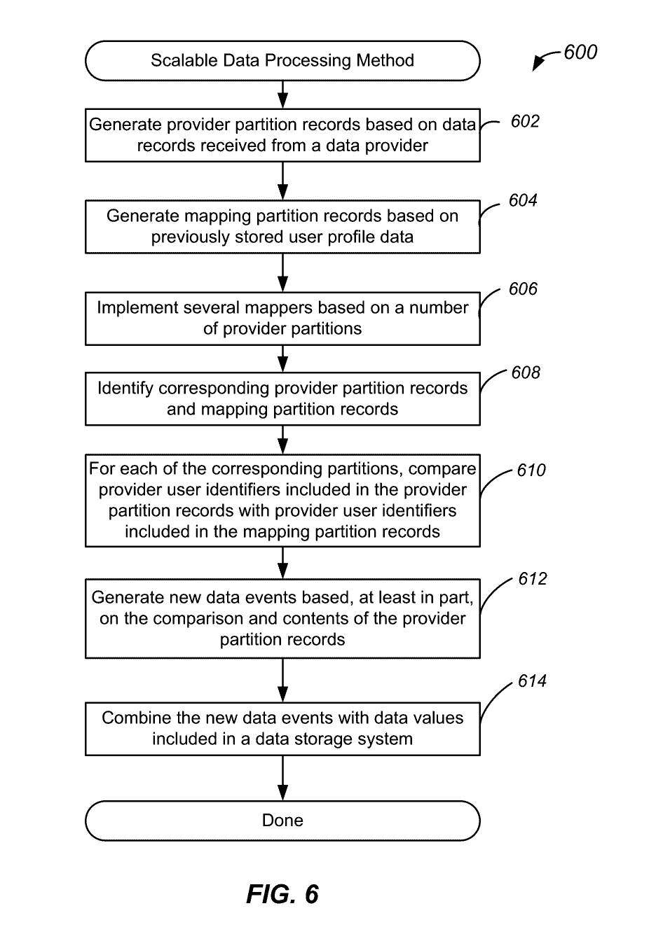

Method 400 may proceed to operation 412 during which, new data events may be generated based on the user identifier mapping and the provider partition records. As will be discussed in greater detail below with reference to FIG. 6, corresponding partitions of the provider partition records and mapping partition records may be identified. The corresponding partitions may be analyzed and new data events may be generated based, at least in part, on a mapping identified by corresponding mapping partition records as well as the contents of the provider partition records. In this way, new data events may be generated that include the data events characterized or represented by the provider partition records and received from the data providers, where the new data events are associated with local user identifiers associated with a second user domain instead of the first user domain. As will discussed in greater detail below, each set of corresponding partition records may be analyzed, and entries within them may be compared to generate the new data events based on the data events included in the provider partition records. Furthermore, as discussed in greater detail with reference to FIG. 6, unique identifiers, such as hash values, of the data records as well as previously stored data may be analyzed to determine whether or not at least some of the received data records have already been stored by the online advertisement service provider, and whether the generation and storage of new data events should not be performed, thus reducing duplicative data entries. Moreover, the provider partition records may be processed in parallel to enable the efficient and scalable processing of a very large amount of data within a particular operational window.

Method 400 may proceed to operation 414 during which the new data events may be combined with data values included in a data storage system. In various embodiments, once the new data events have been generated, they may be combined with data stored by an online advertisement service provider. In this way, the data events originally included in the data records received from the data providers may be integrated with data stored by the online advertisement service provider using local user identifiers in a second user domain. As discussed above, the data events included in the provider partition records were originally included in the received data provider records. Accordingly, the new data events may be combined with user profile data stored in a data storage system operated and maintained by an online advertisement service provider. Moreover, as discussed in greater detail below with reference to FIG. 6, such combining may be performed based on a comparison of the previously described unique identifiers, which may be hash values. As will also be discussed in greater detail below with reference to FIG. 6, such combining may be performed as part of a batch operation enabled by the previously generated user identifier mapping and local user identifiers included in the new data events. Thus, a system component, such as a data analyzer, may store the combined data as the most recent version of performance data and user profile data in the data storage system. In this way, user profile data and performance data stored in the data storage system may be updated to include additional data events that may have been received from data providers such as third party data providers, and may have been combined with existing data that was stored in the data storage system. Moreover, the combining of the data provider data with the data in the data storage system may be performed as part of a single join operation, and multiple data storage system accesses may be reduced.

While FIG. 4 illustrates an example of scalable data processing method 400, various embodiments are contemplated and disclosed herein in which one or more operations of method 400 may be implemented in parallel or in a different order. For example, operations 402, 404, 406, and 410 may be implemented in parallel with operations 410, 412, and 414. In this way, method 400 may simultaneously implement a first sequence of operations 402, 404, 406, and 408 as well as a second sequence of operations 410, 412, and 414. In various embodiments, such parallelization of operations may further reduce an overall time taken to implement method 400 and reduce a size of an operational window or time period in which method 400 may be implemented.

FIG. 5 illustrates a flow chart of an example of yet another scalable data processing method, implemented in accordance with some embodiments. As discussed above, the integration of received data events with data stored in a data storage system may include generating provider partition records as well as a user identifier mapping associated with the provider partition records. As will be discussed in greater detail below, the user identifier mapping may include mapping partition records that enable the parallel processing of large amounts of received data in an efficient and scalable manner.

Method 500 may commence with operation 502 during which user profile data associated with at least one online advertisement campaign may be stored. As discussed above, during the operation of the online advertisement service provider, various online advertisement campaigns may have been previously implemented by various advertisers. During these previously implemented online advertisement campaigns data may be been previously retrieved from data providers such as third party data providers. The previously retrieved data may include performance data and user profile data associated with the previously implemented online advertisement campaigns. In contrast to data underlying the provider partition records discussed above, the data stored during operation 502 may have been received farther in the past than a designated period of time. For example, such previously implemented online advertisement campaigns may have been implemented months in the past, whereas data underlying the provider partition records may have been received during a most recent operational time period, such as a business day, a week, or a most recent month. In various embodiments, the previously retrieved data may include various data categories associated with users for which data events were generated during the previous implementation of the online advertisement campaigns. The previously retrieved data may also include provider user identifiers that identify the users based on the data provider's user domain. In some embodiments, the user profile data may include a separate data structure or record that includes a list that identifies provider user identifiers used by the data provider. Accordingly, based on previous implementations of online advertisement campaigns and/or interactions with data providers, the online advertisement service provider may have previously generated data that identifies provider user identifiers generated based on provider user domains.

Method 500 may proceed to operation 504 during which a first user identifier mapping may be stored. The first user identifier mapping may be associated with the performance data and the user profile data. Accordingly, the first user identifier mapping may be stored with performance data associated with users, such as advertisement impressions served, clicks, advertisement segments, as well as other data events. Moreover, the first user identifier mapping may be stored periodically as part of the online advertisement service provider's advertisement operations performed when providing services to advertisers during previous implementations of advertisement campaigns. In various embodiments, the first user identifier mapping may be configured to map local user identifiers to provider user identifiers. For example, the first user identifier mapping may include a data structure for each data provider that includes local user identifiers in one column and provider user identifiers in another column. Moreover, the first user identifier mapping may be configured to return a provider user identifier for a given local user identifier.

Method 500 may proceed to operation 506 during which a second user identifier mapping may be generated based on the first user identifier mapping. In various embodiments, the second user identifier mapping may be generated by a system component, such as a partition record generator, and may include a reverse mapping of the first user identifier mapping. For example, the second user identifier mapping may be configured to map provider user identifiers to local user identifiers. Accordingly, the second user identifier mapping may include a data structure that includes provider identifiers in a first column, provider user identifiers in a second column, and local user identifiers in a third column. Moreover, the second user identifier mapping may be configured to return a local user identifier for a given provider user identifier.

Method 500 may proceed to operation 508 during which second data provider records and mapping partition records may be generated based on the second user identifier mapping. In various embodiments, the second user identifier mapping generated during operation 506 may be a single data structure. Accordingly, the second user identifier mapping may be modified to generate second data provider records and mapping partition records that correspond to the provider records and provider partition records discussed previously with reference to FIG. 4. Accordingly, the second user identifier mapping may first be divided based on provider identifiers to generate second data provider records such that each of the second data provider records includes data values characterizing a relationship, mapping, or association between a particular data provider's user domain and the online advertisement service provider's user domain. In this way, a separate data structure may be generated for each data provider based on the user profile data. As similarly discussed above, such data structures may be folders.

Furthermore, associations between identifiers represented in the second user identifier mapping may be partitioned based on provider user identifiers included in the second user identifier mapping. For example, a partitioning function may be applied to the provider user identifiers, and a separate mapping partition record may be generated based on the results of the application of the partitioning function to the provider user identifiers. In various embodiments, the partitioning function may be the same partitioning function as described above with reference to operation 406 of FIG. 4. In this way, the second user identifier mapping may be partitioned using the same partitioning function as was used to generate the provider partition records. Because the same partitioning function has been used, the mapping partition records may be generated such that they correspond to the provider partition records. As disclosed herein, corresponding partition records may be partition records that are configured to include the same sets of provider user identifiers for the same data providers. Accordingly, provider user identifiers may be similarly partitioned amongst provider partition records as well as mapping partition records.

Method 500 may proceed to operation 510 during which the mapping partition records may be sorted based on provider user identifiers included in the partition records. In various embodiments, each mapping partition record may include several identified provider user identifier to local user identifier associations. Accordingly, the identified associations may be sorted based on one or more data values of the provider user identifiers. For example, the identified associations may be sorted in ascending or descending order. In various embodiments, the mapping partition records may be sorted in the same manner as the provider partition records. In this way, sorted mapping partition records may be generated that include identified associations between provider user identifiers and local user identifiers that are represented in data structures that correspond to the provider partition records discussed above with reference to FIG. 4. As will be discussed in greater detail below, the generation of such corresponding partitions may enable the efficient and scalable integration of large amounts of data during a relatively small period of time.

FIG. 6 illustrates a flow chart of an example of another scalable data processing method, implemented in accordance with some embodiments. As discussed above, a system component, such as a partition record analyzer, may be configured to analyze partition records and merge data included in the partition records based on the analysis. In this way, corresponding partitions and a generated user identifier mapping represented therein may be implemented to merge or join a large amount of data with user profile data in a data storage system as part of a single join operation.

Method 600 may commence with operation 602 during which provider partition records may be generated based on data records received from a data provider. As discussed above with reference to FIG. 4, a partition record generator may be configured to apply one or more deterministic algorithms to the data provider records that were generated based on data records received from various data providers. In some embodiments, the partitioning may be performed based on a user domain associated with a data provider. The partition record generator may identify the provider user identifiers included in the data provider record, and may assign data events associated with the provider user identifiers to different partition records based on the provider user identifiers. As similarly discussed above, the provider partition records may be stored in data structures, such as folders, that may have been generated for each data provider during operation 404 discussed above. As previously discussed, a partitioning function may be applied to the provider user identifiers. In some embodiments, the partitioning function is a modulus function that divides each provider user identifier by a designated number to obtain a remainder. As similarly discussed above, provider user identifiers may be represented as numerical strings. Accordingly, provider user identifiers may be associated with different provider partition records based on the remainders determined by the application of the modulus function to the provider user identifiers.

Method 600 may proceed to operation 604 during which mapping partition records may be generated based on previously stored user profile data. As discussed above with reference to FIG. 5, a user identifier mapping may be used to generate mapping partition records that correspond to the provider partition records discussed previously with reference to FIG. 4 and operation 602. Accordingly, associations between identifiers represented in the second user identifier mapping may be partitioned based on provider user identifiers included in the second user identifier mapping. For example, a partitioning function may be applied to the provider user identifiers, and a separate mapping partition record may be generated based on the results of the application of the partitioning function to the provider user identifiers. In various embodiments, the partitioning function may be the same partitioning function as described above with reference to operation 602. In this way, the second user identifier mapping may be partitioned using the same partitioning function as was used to generate the provider partition records. Because the same partitioning function has been used, the mapping partition records may be generated such that they correspond to the provider partition records. Accordingly, provider identifiers may be similarly partitioned amongst provider partition records as well as mapping partition records.

Method 600 may proceed to operation 606 during which several mappers may be implemented based on a number of provider partition records. In various embodiments, the mappers may be implemented as part of a Hadoop framework that may be configured to implement one or more components of systems for importing and processing data associated with an advertisement campaign as disclosed herein. Accordingly, mappers may be configured to handle the analysis of corresponding partitions discussed in greater detail below. As discussed above, mappers may be implemented by a system component, such as a data analyzer. More specifically, mappers may be implemented by a partition record analyzer and may be implemented within the partition record analyzer to dynamically configure processing capabilities of the partition record analyzer in a scalable manner. In some embodiments, a number of mappers implemented may be determined dynamically. Moreover, the number of mappers implemented may be determined based on a number of provider partition records generated during operation 602. For example, if 400 provider partition records have been generated, 400 mappers may be implemented. Accordingly, each mapper may be configured to analyze a single provider partition record and its corresponding mapping partition record. In this way, the mappers may be configured and implemented to scalably handle a subsequent analysis of all partitions in parallel.

Method 600 may proceed to operation 608 during which corresponding provider partition records and mapping partition records may be identified. In various embodiments, partition records may be determined to be corresponding when they are both associated with the same data provider and also share a same partition identifier. In some embodiments, the partition identifier may be a partition number. For example, if provider partition records include a first numbered partition record that is associated with a first data provider, then a second numbered partition record of the mapping partition records may be determined to be a corresponding or matching partition record if the second numbered partition record includes the same data provider identifier as well as the same partition identifier as the first numbered partition record. In various embodiments, if it is determined that there are no corresponding partition records, a system component, such as a data analyzer, may be configured to generate new data objects and new associated local user identifiers which may subsequently be stored in a data storage system. The new data objects may include the data, such as data provider identifiers, provider user identifiers, and data events. Accordingly, the data storage system may be updated to include data associated with users for which there is no previous data.

However, according to various embodiments, there may be several corresponding partition records. In the context of ingestion of large amounts of data in “big data” analysis, there may be thousands of corresponding partition records, if not more. Accordingly, during operation 608, a first pair of corresponding partition records may be selected for analysis. In some embodiments, the corresponding pair may be selected based on data provider identifiers and partition identifiers. In various embodiments, the corresponding partition records may be sorted and ordered based on data provider identifiers, which may be numerical numbers, and partition identifiers, which may also be numerical identifiers. Thus, the corresponding partition records may be sorted and ordered, and iteratively analyzed.

Accordingly, if corresponding partition records are identified, method 600 may proceed to operation 610 during which, for each of the corresponding partitions, provider user identifiers included in the provider partition records may be compared with provider user identifiers included in the mapping partition records. In various embodiments, a system component, such as a partition record analyzer, may be configured to iteratively analyze provider user identifiers included in each of the corresponding partition records and compare the provider user identifiers to identify any matching provider user identifiers. In some embodiments, the partition record analyzer may incrementally proceed through the sorted provider user identifiers, where the incrementing of a provider user identifier included in a provider partition record and/or a mapping partition record is based on a result of each comparison.

For example, a first partition record may be a provider partition record and may include provider user identifiers 1, 3, and 5. A second partition record may be a corresponding mapping partition record that may include provider user identifiers 2, 3, and 4. The partition record analyzer may first compare the first provider user identifiers from each partition record, which in this example are 1 and 2. Upon performing a comparison and determining that 1 is smaller than 2, the partition record analyzer may analyze the next value from the first partition record, which is 3. The partition record analyzer may then compare 3 and 2. Upon determining that 2 is smaller than 3, the partition record analyzer may analyze the next value from the second partition record. Accordingly, the partition record analyzer may compare 3 and 3. Upon determining that the provider user identifiers are the same, the partition record analyzer may identify a match. As will be discussed in greater detail below, modification and join operations may be performed dynamically upon identifying a match, or may be performed after all matches have been identified for all partitions. In various embodiments, the partition record analyzer may continue to analyze the first and second partition records. For example, the partition record analyzer may continue to compare 5 and 4 and proceed as similarly discussed above.

Furthermore, during operation 610, unique identifiers generated based on third party data may be compared to ensure that redundant data events are not generated and stored during subsequent operations 612 and 614 discussed in greater detail below. In some embodiments, as part of a data processing method, an online advertisement service provider may generate a unique identifier that represents contents of a data record that has been received and stored. In one example, during previous data storage events which may have occurred during previous iterations of method 600 or previous storage of third party data, a system component, such as a data analyzer, may be configured to generate a first unique identifier, such as a hash value, based on the contents of the third party data record and a hash function. The unique identifier may be stored in the data storage system along with any associated third party data. This may be performed for each data record that is received. In various embodiments, the previously generated unique identifiers may be stored in their associated mapping partition records. As previously discussed above, the mapping partition records may have been generated based, at least in part, on a previously stored identifier mapping that may have been generated based on previously received third party data. Accordingly, each provider user identifier included in the mapping partition records may be stored with a unique identifier, such as a hash value, that represents the data record that originally included that provider user identifier.

In various embodiments, during operation 610, if a match between provider user identifiers is determined to exist, a system component, such as a data analyzer, may generate a second unique identifier, which may be a second hash value, based on the data record that was received at operation 602, and as discussed above with reference to operation 402. In some embodiments, a system component, such as a data analyzer, may maintain state information about each data record received from a data provider. Accordingly, the data analyzer may identify, based on the state information, a data record that originally included a provider user identifier and associated user data or data events included in a provider partition record. The data analyzer may retrieve the associated data record and generate a second unique identifier by, for example, applying a hash function. Thus, according to this example, the second unique identifier represents a newly received data record that is to be included in the data storage system operated and maintained by the online advertisement service provider, and has been partitioned as previously discussed. The second unique identifier may be compared with the first unique identifier included in the mapping partition record, which represents the old or previously received data already stored in the data storage system and associated with this provider user identifier. If the first and second unique identifiers match, it may be determined that the user data and/or data events identified by the provider partition record are not new and have already been stored. Accordingly, as discussed below, operations 612 and 614 might not be performed. However, if it is determined that the first and second unique identifiers do not match, then it may be determined that the user data and/or data events identified by the provider partition record are new, and method 600 may proceed to operation 612.

Accordingly, method 600 may proceed to operation 612 during which new data events may be generated based, at least in part, on the comparison and contents of the provider partition records. As previously discussed with reference to FIG. 4, new data events may be generated based on contents of the provider partition records, which may include one or more data events received from data providers, as well as contents of the mapping partition records, which may include user identifier mappings. In this way, for each match between a provider partition record and a mapping partition record identified during operation 610, a new data event may be generated that includes the data event identified by the matching provider partition record, and further includes the local user identifier identified by the matching mapping partition record. Accordingly, during operation 612 several new data events may be generated that include or characterize data events received from one or more data providers and associated with local user identifiers of a second user domain. In this way, each set of corresponding partition records may be analyzed, and entries within them may be compared to generate new data events for all data events included in the provider partition records.

Returning to a previous example, a system component, such as a partition record analyzer, may have determined that a provider user identifier included in a provider partition record and having a value of “3” matches a provider user identifier included in a corresponding mapping partition record having a value of “3”. In response to determining that the provider user identifiers match, the partition record analyzer may be configured to generate a data structure that characterizes a new data event based on a mapping identified by the corresponding mapping partition record. In this example, the corresponding mapping partition record may identify an association between the provider user identifier “3” and a local user identifier “205”. Accordingly, during operation 612, the new data event may include one or more data values characterizing the data event included in the provider partition record. Moreover, the new data event may include a local user identifier having a value of “205” instead of a value of “3”. In this way, a new data event may be generated for each match identified during operation 610, and based on a mapping identified by corresponding mapping partition records.

As discussed above, the generation of new data events may also be performed responsive to one or more determinations of the unique identifier comparison performed during operation 610. For example, if matching unique identifiers, such as hash values, are identified, operation 612 might not be performed. However, if the unique identifiers are determined to be different, operation 612 may be performed, and may subsequently proceed to operation 614.

Method 600 may proceed to operation 614 during which the new data events may be combined with data values included in a data storage system. As previously discussed with reference to FIG. 4, once the new data events have been generated, the new data events may be combined with data stored by an online advertisement service provider. In this way, the data events and user profile data that was received from data providers may be included with data stored by the online advertisement service provider. As discussed above, the new data events may characterize or represent data events included in the provider partition records that were originally represented in the received data provider records. Accordingly, the new data events may be combined with user profile data stored in a data storage system operated and maintained by an online advertisement service provider. Moreover, as similarly discussed above, such combining may be performed based, at least in part, on a comparison of the previously described unique identifiers, which may be hash values. Thus, a system component, such as a data analyzer, may store the combined data as the most recent version of performance data and user profile data in the data storage system. In this way, user profile data and performance data stored in the data storage system may be updated to include additional data events that may have been received from data providers such as third party data providers, and may have been combined with existing data that was stored in the data storage system. Moreover, the combining of the data provider data with the data in the data storage system may be performed as part of a single join operation, and multiple data storage system accesses may be reduced.

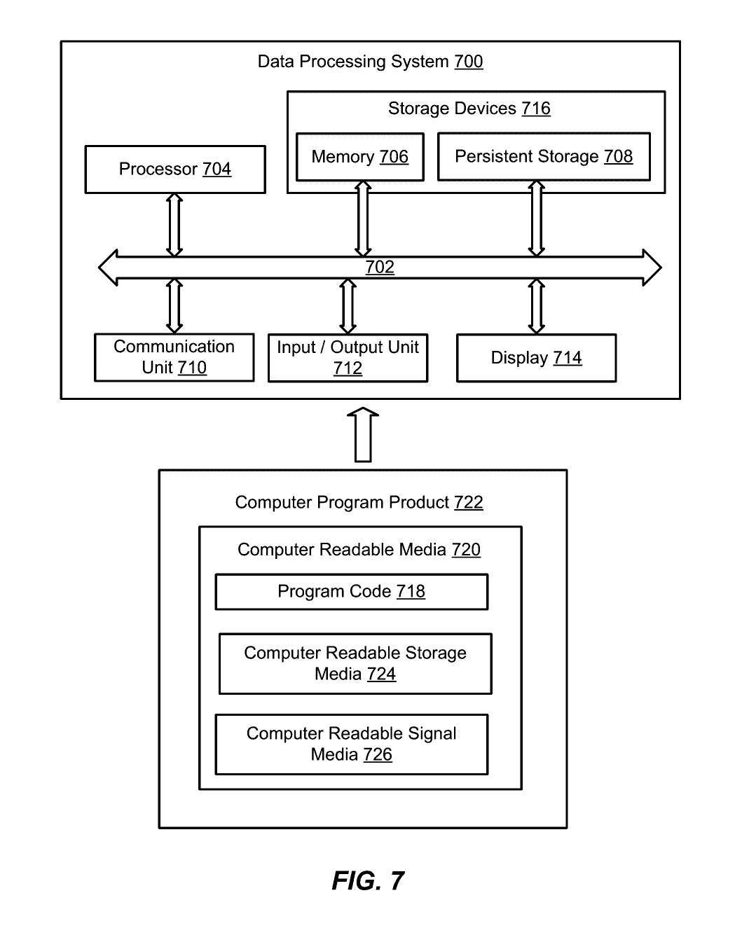

FIG. 7 illustrates a data processing system configured in accordance with some embodiments. Data processing system 700, also referred to herein as a computer system, may be used to implement one or more computers or processing devices used in a controller, server, or other components of systems described above, such as a data analyzer. In some embodiments, data processing system 700 includes communications framework 702, which provides communications between processor unit 704, memory 706, persistent storage 708, communications unit 710, input/output (I/O) unit 712, and display 714. In this example, communications framework 702 may take the form of a bus system.

Processor unit 704 serves to execute instructions for software that may be loaded into memory 706. Processor unit 704 may be a number of processors, as may be included in a multi-processor core. In various embodiments, processor unit 704 is specifically configured to process large amounts of data that may be involved when processing performance data associated with one or more advertisement campaigns, as discussed above. Thus, processor unit 704 may be an application specific processor that may be implemented as one or more application specific integrated circuits (ASICs) within a processing system. Such specific configuration of processor unit 704 may provide increased efficiency when processing the large amounts of data involved with the previously described systems, devices, and methods. Moreover, in some embodiments, processor unit 704 may be include one or more reprogrammable logic devices, such as field-programmable gate arrays (FPGAs), that may be programmed or specifically configured to optimally perform the previously described processing operations in the context of large and complex data sets sometimes referred to as “big data.”

Memory 706 and persistent storage 708 are examples of storage devices 716. A storage device is any piece of hardware that is capable of storing information, such as, for example, without limitation, data, program code in functional form, and/or other suitable information either on a temporary basis and/or a permanent basis. Storage devices 716 may also be referred to as computer readable storage devices in these illustrative examples. Memory 706, in these examples, may be, for example, a random access memory or any other suitable volatile or non-volatile and/or non-transitory storage device. Persistent storage 708 may take various forms, depending on the particular implementation. For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708.

Communications unit 710, in these illustrative examples, provides for communications with other data processing systems or devices. In these illustrative examples, communications unit 710 is a network interface card.

Input/output unit 712 allows for input and output of data with other devices that may be connected to data processing system 700. For example, input/output unit 712 may provide a connection for user input through a keyboard, a mouse, and/or some other suitable input device. Further, input/output unit 712 may send output to a printer. Display 714 provides a mechanism to display information to a user.

Instructions for the operating system, applications, and/or programs may be located in storage devices 716, which are in communication with processor unit 704 through communications framework 702. The processes of the different embodiments may be performed by processor unit 704 using computer-implemented instructions, which may be located in a memory, such as memory 706.

These instructions are referred to as program code, computer usable program code, or computer readable program code that may be read and executed by a processor in processor unit 704. The program code in the different embodiments may be embodied on different physical or computer readable storage media, such as memory 706 or persistent storage 708.

Program code 718 is located in a functional form on computer readable media 720 that is selectively removable and may be loaded onto or transferred to data processing system 700 for execution by processor unit 704. Program code 718 and computer readable media 720 form computer program product 722 in these illustrative examples. In one example, computer readable media 720 may be computer readable storage media 724 or computer readable signal media 726.

In these illustrative examples, computer readable storage media 724 is a physical or tangible storage device used to store program code 718 rather than a medium that propagates or transmits program code 718.

Alternatively, program code 718 may be transferred to data processing system 700 using computer readable signal media 726. Computer readable signal media 726 may be, for example, a propagated data signal containing program code 718. For example, computer readable signal media 726 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for data processing system 700 are not meant to provide architectural limitations to the manner in which different embodiments may be implemented. The different illustrative embodiments may be implemented in a data processing system including components in addition to and/or in place of those illustrated for data processing system 700. Other components shown in FIG. 7 can be varied from the illustrative examples shown. The different embodiments may be implemented using any hardware device or system capable of running program code 718.

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatus. Accordingly, the present examples are to be considered as illustrative and not restrictive.

What is claimed is:

1. A system comprising:
a data aggregator configured to receive a plurality of data records generated by at least one data provider, and the data aggregator being further configured to receive user profile data generated by an online advertisement service provider, the plurality of data records and the user profile data each identifying at least one data event and at least one user, and the user profile data including a first user identifier mapping;
a data provider record generator configured to generate a first plurality of data provider records based on a first plurality of identifiers included in the plurality of data records, and the data provider record generator being further configured to generate a second plurality of data provider records based on a second plurality of identifiers included in the user profile data;
a partition record generator configured to generate a plurality of provider partition records based on the first plurality of data provider records, and the partition record generator being further configured to generate a plurality of mapping partition records based on the second plurality of data provider records, the plurality of mapping partition records including a second user identifier mapping; and
a partition record analyzer configured to generate a plurality of new data events based on the second user identifier mapping represented in the plurality of mapping partition records and at least some of the plurality of provider partition records, the partition record analyzer being further configured to update the user profile data based on a combination of at least some of the plurality of new data events and at least some of the user profile data.

2. The system of claim 1, wherein the plurality of data records comprises a first plurality of data values characterizing a first plurality of provider user identifiers associated with a first plurality of users, a first plurality of data events associated with the first plurality of users, and a first plurality of data provider identifiers associated with a first plurality of data providers, and
wherein the user profile data comprises a second plurality of data values characterizing a second plurality of provider user identifiers associated with a second plurality of users, a second plurality of data events associated with the second plurality of users, and a second plurality of data provider identifiers associated with a second plurality of data providers.

3. The system of claim 2, wherein each data provider record of the first plurality of data provider records is generated based on a data provider identifier of the first plurality of data provider identifiers, and wherein each data provider record of the second plurality of data provider records is generated based on a data provider identifier of the second plurality of data provider identifiers.

4. The system of claim 3, wherein each provider partition record of the plurality of provider partition records is generated based on at least one provider user identifier of the first plurality of provider user identifiers, and wherein each mapping partition record of the plurality of mapping partition records is generated based on at least one provider user identifier of the second plurality of provider user identifiers.

5. The system of claim 4, wherein each provider partition record of the plurality of provider partition records represents a portion of the first plurality of provider user identifiers, and wherein each mapping partition record of the plurality of mapping partition records represents a portion of the second plurality of provider user identifiers.

6. The system of claim 4, wherein the partition record generator is further configured to generate the plurality of provider partition records by applying a mapping function to the first plurality of provider user identifiers included in the first plurality of data provider records, and
wherein the partition record generator is further configured to generate the plurality of mapping partition records by applying the mapping function to the second plurality of provider user identifiers included in the second plurality of data provider records.

7. The system of claim 1, wherein the partition record analyzer is further configured to identify corresponding partition records of the plurality of provider partition records and the plurality of mapping partition records,
wherein the partition record analyzer is further configured to compare provider user identifiers included in the corresponding partition records, and
wherein the partition record analyzer is further configured to generate the plurality of new data events based on the comparison.

8. The system of claim 7, wherein the partition record analyzer is further configured to store the updated user profile data in a data storage system associated with an online advertisement service provider.

9. The system of claim 8, wherein the partition record analyzer is further configured to replace previously stored user profile data with the updated user profile data to generate updated user profiles and performance data associated with online advertisement campaigns.

10. The system of claim 1, wherein the user profile data comprises a plurality of performance data objects characterizing performance data capable of being used by an online advertisement campaign.

11. A device comprising:
a first processing node configured to receive a plurality of data records generated by at least one data provider, and the first processing node being further configured to receive user profile data generated by an online advertisement service provider, the plurality of data records and the user profile data each identifying at least one data event and at least one user, and the user profile data including a first user identifier mapping;
a second processing node configured to generate a first plurality of data provider records based on a first plurality of identifiers included in the plurality of data records, and the second processing node being further configured to generate a second plurality of data provider records based on a second plurality of identifiers included in the user profile data;
a third processing node configured to generate a plurality of provider partition records based on the first plurality of data provider records, and the third processing node being further configured to generate a plurality of mapping partition records based on the second plurality of data provider records, the plurality of mapping partition records including a second user identifier mapping; and
a fourth processing node configured to generate a plurality of new data events based on the second user identifier mapping represented in the plurality of mapping partition records and at least some of the plurality of provider partition records, the fourth processing node being further configured to update the user profile data based on a combination of at least some of the plurality of new data events and at least some of the user profile data.

12. The device of claim 11, wherein the plurality of data records comprises a first plurality of data values characterizing a first plurality of provider user identifiers associated with a first plurality of users, a first plurality of data events associated with the first plurality of users, and a first plurality of data provider identifiers associated with a first plurality of data providers, and
wherein the user profile data comprises a second plurality of data values characterizing a second plurality of provider user identifiers associated with a second plurality of users, a second plurality of data events associated with the second plurality of users, and a second plurality of data provider identifiers associated with a second plurality of data providers.

13. The device of claim 12, wherein each data provider record of the first plurality of data provider records is generated based on a data provider identifier of the first plurality of data provider identifiers, and wherein each data provider record of the second plurality of data provider records is generated based on a data provider identifier of the second plurality of data provider identifiers.

14. The device of claim 13 wherein each provider partition record of the plurality of provider partition records is generated based on at least one provider user identifier of the first plurality of provider user identifiers, and wherein each mapping partition record of the plurality of mapping partition records is generated based on at least one provider user identifier of the second plurality of provider user identifiers.

15. The device of claim 14, wherein the third processing node is further configured to generate the plurality of provider partition records by applying a mapping function to the first plurality of provider user identifiers included in the first plurality of data provider records, and
wherein the third processing node is further configured to generate the plurality of mapping partition records by applying the mapping function to the second plurality of provider user identifiers included in the second plurality of data provider records.

16. The device of claim 11, wherein the fourth processing node is further configured to identify corresponding partition records of the plurality of provider partition records and the plurality of mapping partition records,
wherein the fourth processing node is further configured to compare provider user identifiers included in the corresponding partition records, and
wherein the fourth processing node is further configured to generate the plurality of new data events based on the comparison.

17. One or more non-transitory computer readable media having instructions stored thereon for performing a method, the method comprising:
receiving a plurality of data records generated by at least one data provider and user profile data generated by an online advertisement service provider, the plurality of data records and the user profile data each identifying at least one data event and at least one user, and the user profile data including a first user identifier mapping;
generating a first plurality of data provider records based on a first plurality of identifiers included in the plurality of data records,
generating a second plurality of data provider records based on a second plurality of identifiers included in the user profile data;
generating a plurality of provider partition records based on the first plurality of data provider records;
generating a plurality of mapping partition records based on the second plurality of data provider records, the plurality of mapping partition records including a second user identifier mapping;
generating a plurality of new data events based on the second user identifier mapping represented in the plurality of mapping partition records and at least some of the plurality of provider partition records; and
updating the user profile data based on a combination of at least some of the plurality of new data events and at least some of the user profile data.

18. The one or more non-transitory computer readable media recited in claim 17, wherein the plurality of data records comprises a first plurality of data values characterizing a first plurality of provider user identifiers associated with a first plurality of users, a first plurality of data events associated with the first plurality of users, and a first plurality of data provider identifiers associated with a first plurality of data providers,
wherein the user profile data comprises a second plurality of data values characterizing a second plurality of provider user identifiers associated with a second plurality of users, a second plurality of data events associated with the second plurality of users, and a second plurality of data provider identifiers associated with a second plurality of data providers,
wherein each data provider record of the first plurality of data provider records is generated based on a data provider identifier of the first plurality of data provider identifiers, and
wherein each data provider record of the second plurality of data provider records is generated based on a data provider identifier of the second plurality of data provider identifiers.

19. The one or more non-transitory computer readable media recited in claim 18, wherein the generating of the plurality of provider partition records and the generating of the plurality of mapping partition records further comprise:
applying a mapping function to the first plurality of provider user identifiers included in the first plurality of data provider records; and
applying the mapping function to the second plurality of provider user identifiers included in the second plurality of data provider records.

20. The one or more non-transitory computer readable media recited in claim 19, wherein the method further comprises:
identifying corresponding partition records of the plurality of provider partition records and the plurality of mapping partition records;
comparing provider user identifiers included in the corresponding partition records; and
generating the plurality of new data events based on the comparing.
